(19) United States
(12) Patent Application Publication
(10) Pub. No.: US 2026/0283894 A1
(43) Pub. Date: Sep. 24, 2026

(54) FOOT MASSAGER

(71) Applicant: Reestar International Limited, Hong Kong (CN)

(72) Inventors: Xili Wu, Hong Kong (CN); Baoyan Wei, Hong Kong (CN); Gaoming Liang, Hong Kong (CN)

(21) Appl. No.: 19/215,437

(22) Filed: May 22, 2025

(30) Foreign Application Priority Data
Mar. 21, 2025 (CN) 202520511640.2

(51) Int. Cl. A61H 9/00

(52) U.S. Cl. CPC A61H 9/0078; A61H 2201/0207; A61H 2201/0221; A61H 2201/1215; A61H 2201/1246; A61H 2201/164; A61H 2201/1671; A61H 2201/1695; A61H 2201/5082; A61H 2205/12

(57) ABSTRACT

A foot massager includes: a massager body, defining a foot receiving cavity; a mounting member, mounted on the massager body; a massager head, configured to massage a foot of a user; and a heating assembly. A heating space is formed between the massager head and the mounting member, at least one heat-transmitting hole is defined in the massager head, and the at least one heat-transmitting hole provides communication between the heating space and the foot receiving cavity. The heating assembly is received in the heating space, and the heating assembly is configured to heat the heating space and the massager head.

### CROSS REFERENCE TO RELATED APPLICATIONS

The present application claims the priority of the Chinese patent application No. 202520511640.2, filed on Mar. 21, 2025, contents of which are incorporated herein by its entireties.

### TECHNICAL FIELD

Embodiments of the present disclosure relate to the technical field of massage devices, and more specifically, to a foot massager.

### BACKGROUND

Massage devices can promote blood circulation, enhance metabolism, and effectively improve various chronic diseases. For example, a foot massager may stimulate foot acupuncture points to dredge meridians and improve blood circulation, so as to fully adjust metabolism of a human body. In the related art, the foot massager generally has a massager head, and the massager head may press on parts of the human body. However, the foot massager in the related art takes only the massager head to press on foot, and therefore, a limited massaging effect can be achieved. Especially in cold weather, blood vessels may be contracted, an effect of dredging meridians and improving blood circulation may be poor, resulting in a poor user experience.

### SUMMARY

The present disclosure provides a foot massager, including: a massager body, defining a foot receiving cavity; a mounting member, mounted on the massager body; a massager head, configured to massage a foot of a user; and a heating assembly. A heating space is formed between the massager head and the mounting member, at least one heat-transmitting hole is defined in the massager head, and the at least one heat-transmitting hole provides communication between the heating space and the foot receiving cavity. The heating assembly is received in the heating space, and the heating assembly is configured to heat the heating space and the massager head.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a structural schematic view of a foot massager according to an embodiment of the present disclosure.

FIG. 2 is an exploded view of the foot massager shown in FIG. 1.

FIG. 3 is a structural schematic view of a second massage assembly shown in FIG. 2.

FIG. 4 is a structural schematic view of the second massage assembly shown in FIG. 2, being viewed from another viewing angle.

FIG. 5 is a cross-sectional view of the second massage assembly shown in FIG. 3, taken along a line A′-A′.

FIG. 6 is an exploded view of the second massage assembly shown in FIG. 3.

FIG. 7 is another exploded view of the second massage assembly shown in FIG. 3.

FIG. 8A is a structural schematic view of a massager head shown in FIG. 7.

FIG. 8B is another structural schematic view of the massager head shown in FIG. 7.

FIG. 9 is a structural schematic view of a bottom of the massager head shown in FIG. 8A.

FIG. 10 is a structural schematic view of a mounting member shown in FIG. 7.

FIG. 11 is a structural schematic view of a rear of the mounting member shown in FIG. 10.

FIG. 12 is a structural schematic view of a heating assembly shown in FIG. 7.

FIG. 13 is a structural schematic view of connection between a control module and the heating assembly in the foot massager according to an embodiment of the present disclosure.

### DETAILED DESCRIPTIONS

In order to make objectives, technical solutions and advantages of the embodiments of the present disclosure clearer, technical solutions in the embodiments of the present application will be clearly and completely described below by referring to the accompanying drawings.

It should be noted that all directional indications (such as up, down, left, right, front, rear, top, bottom) in the embodiments of the present disclosure are only used to explain relative positional relationships, movements, and so on, between components at a particular attitude (the attitude as shown in the accompanying drawings). When the particular attitude is changed, the directional indications are changed accordingly. In the embodiments of the present disclosure, descriptions based on the “first”, “second”, and so on are used for descriptive purposes only, and do not indicate or imply relative importance or implicitly specify the number of any indicated technical features. Therefore, a feature defined as “first” or “second” may include at least one such feature, either explicitly or implicitly.

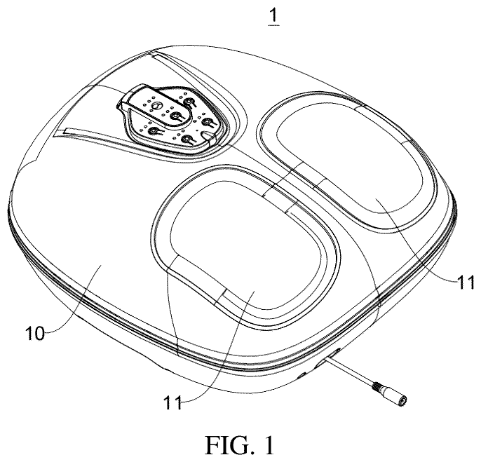

As shown in FIGS. 1 to 5, the present disclosure provides a foot massager 1 including a massager body 10, a mounting member 100, a massager head 200, and a heating assembly 20.

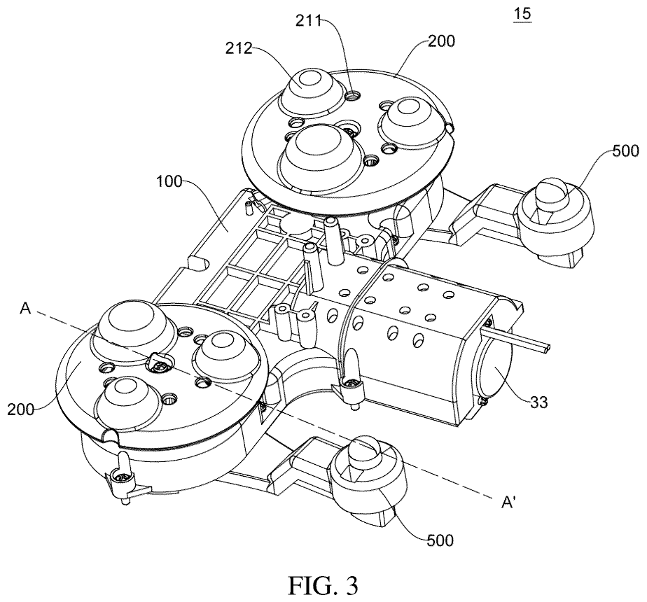

As shown in FIG. 1, the massager body 10 defines a foot receiving cavity 11, and a flexible spacer is received in the foot receiving cavity 11. The flexible spacer is configured to receive a foot of a user. The flexible spacer may be a cloth bag or a cotton bag. The mounting member 100, the massager head 200 and the heating assembly 20 are disposed inside the massager body 10. As shown in FIG. 3, the massager head 200 is disposed at an upper side of the mounting member 100 and extends to be received in the foot receiving cavity 11. The flexible spacer covers the massager head 200, and the massager head 200 massages the foot with the flexible spacer disposed between the massager head 200 and the foot. The massager head 200 defines at least one heat-transmitting hole 211. As shown in FIG. 5, a heating space 101 is formed between the massager head 200 and the mounting member 100. The at least one heat-transmitting hole 211 defined in the massager head 200 provides communication between the heating space 101 and the foot receiving cavity 11. The heating assembly 20 is received in the heating space 101, and the heating assembly 20 may be attached to an inner wall of the massager head 200 or disposed apart from the massager head 200. The heating assembly 20 is configured to heat air in the heating space 101 and the massager head 200, such that the air may flow through the at least one heat-transmitting hole 211 to a top of the massager head 200 to heat the foot receiving cavity 11.

When the heating assembly 20 starts heating, the air in the heating space 101 can be heated, such that the air in the heating space 101 and air in the foot receiving cavity 11 may perform thermal convection through the at least one heat-transmitting hole 211. In this way, the foot receiving cavity 11 may be warmed up, and the foot of the user may feel the heat. In addition, the air in the heating space 101, after being heated, may conduct the heat to the massager head 200, and the heat may be transferred from the massager head 200 to the foot by way of heat conduction. Furthermore, the heating assembly 20 may directly transmit heat to the flexible spacer based on heat radiation through the at least one heat-transmitting hole 211, and the heat on the flexible spacer may then be transmitted to the foot. Therefore, the heating assembly may transfer heat to the foot in the above three manners, which improves an efficiency of heat transfer, reduces a preheating time length of the foot massager, allowing the foot massager to start operating quickly.

Therefore, at the time when the foot massager 1 takes the massager head 200 to apply pressure to massage the foot, the heating assembly 20 may heat the foot to enhance the effect of dredging the meridians and improving blood circulation, further importing the massaging effect. In addition, by defining the at least one heat-transmitting hole 211, the heating efficiency of the heating assembly 20 increases, enabling the heating assembly 20 to reach a preset temperature in a shorter period of heating time, reducing energy waste, and further improving the user experience. By defining the at least one heat-transmitting hole 211, hot air is enabled to fully fill the foot receiving cavity 11, such that the entire foot of the user can be fully wrapped by the heat, and the user experience is better.

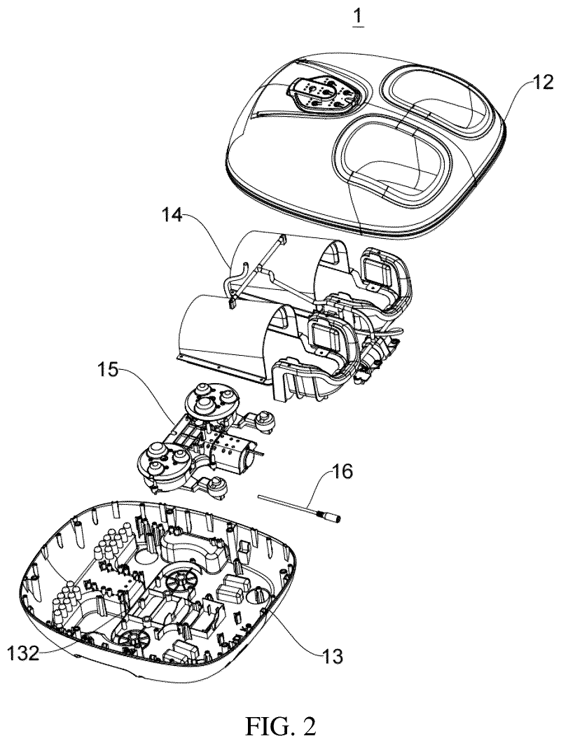

As shown in FIG. 2, the foot massager 1 of the present disclosure includes a first massager assembly 14 and a second massager assembly 15. The first massager assembly 14 is an airbag massager assembly and is configured to take an airbag pressure to press the foot. The second massager assembly 15 is a foot bottom massager assembly. The second massager assembly 15 includes the aforementioned massager head 200, the massager head 200 may rotate to massage a center of the foot bottom. In an embodiment, the second massager assembly 15 further includes a heel massager member 500, the heel massager member 500 is configured to massage a heel of the foot. The massager body 10 includes an upper housing 12 and a lower housing 13. The upper housing 12 and the lower housing 13 are connected to each other to form a shell of the massager body 10. The foot receiving cavity 11 is defined in the upper housing 12.

In an embodiment, the massager head 200 may be made of a rigid material having a high specific heat capacity and a moderate thermal conductivity. In this way, a speed at which the massager head is heated can be reduced, preventing the massager head from being heated excessively quickly, such that the user is protected from being scalded due to reacting to the heat in an untimely manner. Furthermore, the heat in the heating space 101 is prevented from overflowing, through the massager head 200, out in all directions, and at the same time, the heat can be transferred effectively, improving a heating efficiency and a heating effect.

As shown in FIGS. 5 to 7, in an embodiment, the at least one heat-transmitting hole 211 i s located directly opposite to the heating assembly 20. Specifically, the at least one heat-transmitting hole 211 are located directly above the heating assembly 20. Along a direction in which the massager head 200 points towards the mounting member 100, a projection of the at least one heat-transmitting hole 211 and a projection of the heating assembly 20 are at least partially overlapped with each other. In this way, the air heated by the heating assembly 20 may flow upwardly directly to the foot receiving cavity 11 through the at least one heat-transmitting hole 211, such that a transmission path of the heated air is further shortened, and the heating effect is further enhanced. In addition, the heating assembly may directly irradiate the flexible spacer below the foot, facilitating the heat radiation. In the present embodiment, all the heat-transmitting holes 211 are arranged to directly face towards the heating assembly 20. In other embodiments, it is feasible for only a portion of the heat-transmitting holes 211 to be arranged to directly face towards the heating assembly 20.

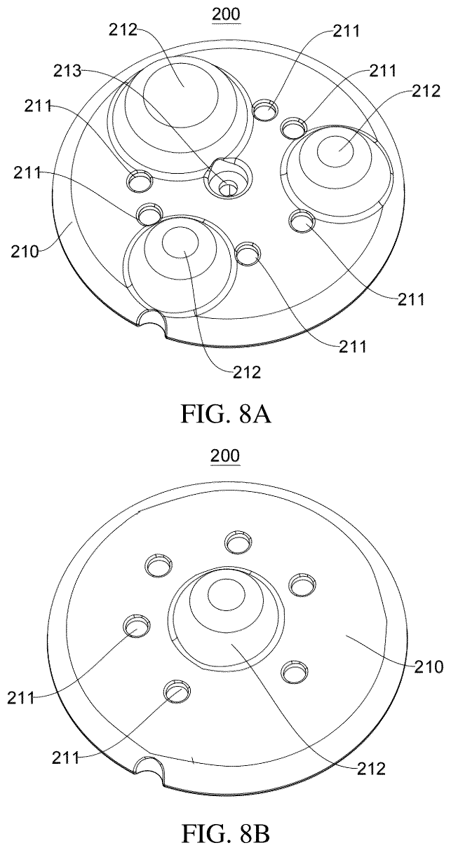

As shown in FIGS. 8A and 8B, the massager head 200 includes a top wall 210 and at least one massaging protrusion 212. The at least one massaging protrusion 212 is disposed on the top wall 210 and is configured to contact and massage the foot bottom. The at least one heat-transmitting hole 211 is defined in the top wall 210 and is disposed near the at least one massaging protrusion 212. In the present embodiment, the at least one heat-transmitting hole 211 and the at least one massaging protrusion 212 are all disposed on the top wall 210. The top wall 210 of the massager head 200 is configured to be disc tray-shaped, and specifically be circular. The at least one heat-transmitting hole 211 is disposed at a side of the at least one massaging protrusion 212. By arranging the at least one massaging protrusion 212 and the at least one heat-transmitting hole 211 at the top wall 210, heating and massaging can be achieved at the same time. In addition, the foot is supported on the at least one massaging protrusion 212 at the massager head 200 by having the flexible spacer disposed between the foot and the massaging protrusion 212, the massaging protrusion 212 is configured to separate the flexible spacer from the at least one heat-transmitting hole, preventing the at least one heat-transmitting hole 211 at the top wall 210 from being blocked, such that transmission of hot air is not affected.

Further, the number of the at least one massaging protrusion 212 is at least two. At least one of the at least one heat-transmitting hole 211 is defined between at least one pair of adjacent massaging protrusions 212 of the at least two massaging protrusions 212. As an example, each pair of adjacent massaging protrusions 212 is provided with a heat-transmitting hole 211. In this way, each of the at least one heat-transmitting hole faces a lower part of the foot, shortening a distance of heat transfer.

In an embodiment, the number of the at least one massaging protrusion 212 is three, and the number of the at least one heat-transmitting hole 211 is six. Two heat-transmitting holes 211 are disposed between every two adjacent massaging protrusions 212, and two heat-transmitting holes 211 are disposed at a side of each massaging protrusion 212. As shown in FIG. 8A, in the present embodiment, the three massaging protrusions 212 and the six heat-transmitting holes 211 are arranged in an annular arrangement. Every two of the three massaging protrusions 212 are disposed next to each other and are spaced apart from each other. Two heat-transmitting holes 211 are arranged at a side edge of each massaging protrusion 212.

As shown in FIG. 8B, in another embodiment, the number of the at least one massaging protrusion 212 may be one and is located at a center of the top wall 210. The number of the at least one heat-transmitting hole 211 is more than one, and the more than one heat-transmitting holes 211 are arranged in a circle surrounding the massaging protrusions 212.

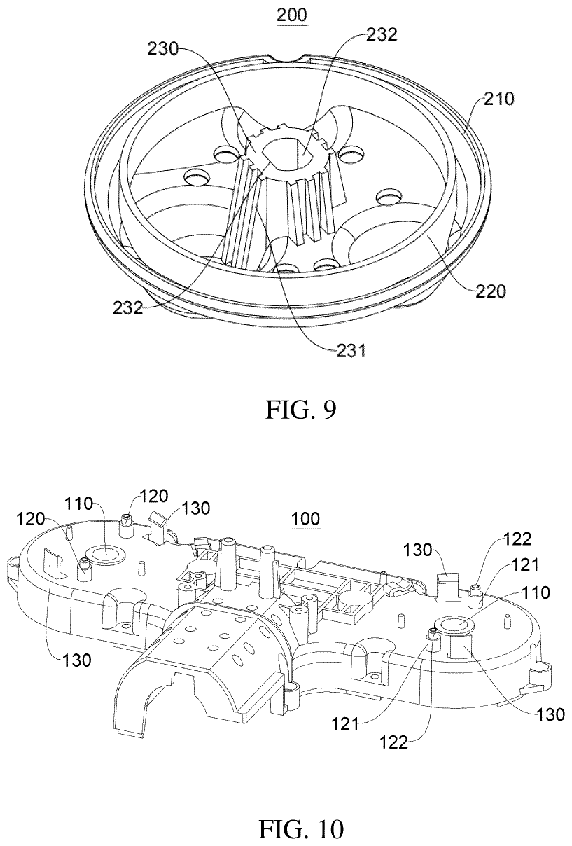

As shown in FIGS. 5 and 9, the massager head 200 further includes a side wall 220, surrounding the top wall 210. The top wall 210, the side wall 220, and the mounting member 100 cooperatively define the heating space 101. As shown in FIG. 9, the side wall 220 is disposed at a lower side of the top wall 210 and extends downwardly, such that the side wall 220 is ring shaped and is disposed near an edge of the top wall 210. In this way, the top wall 210, the side wall 220 and the mounting member 100 cooperatively define the heating space 101. By arranging the side wall 220, the heating space 101 is be enclosed as a relatively small space, improving the heating effect of the heating assembly 20, and the air after being heated is prevented from dispersing around, improving the heat transferring effect.

Further, as shown in FIG. 5, the side wall 220 of the massager head 200 is spaced apart from the mounting member 100, and an air intake gap 201 is formed between the side wall 220 and the mounting member 100. Specifically, the side wall 220 is suspended relative to the mounting member 100, such that the air intake gap 201 is formed between the side wall 220 and the mounting member 100. When the air in the heating space 101 is heated to be expanded and flows upwardly through the at least one heat-transmitting hole 211, air at an outside of the massager may fill into the heating space 101 by flowing through the air intake gap 201, such that air pressure balance is maintained, inducing internal-external air circulation, providing a physical basis for the hot air to flow upwardly. Moreover, due to the hot air flow upwardly, the heated air in the heating space 101, instead of leaking out through the air intake gap 201, flows upwardly into the foot receiving cavity 11 through the at least one heat-transmitting hole 211.

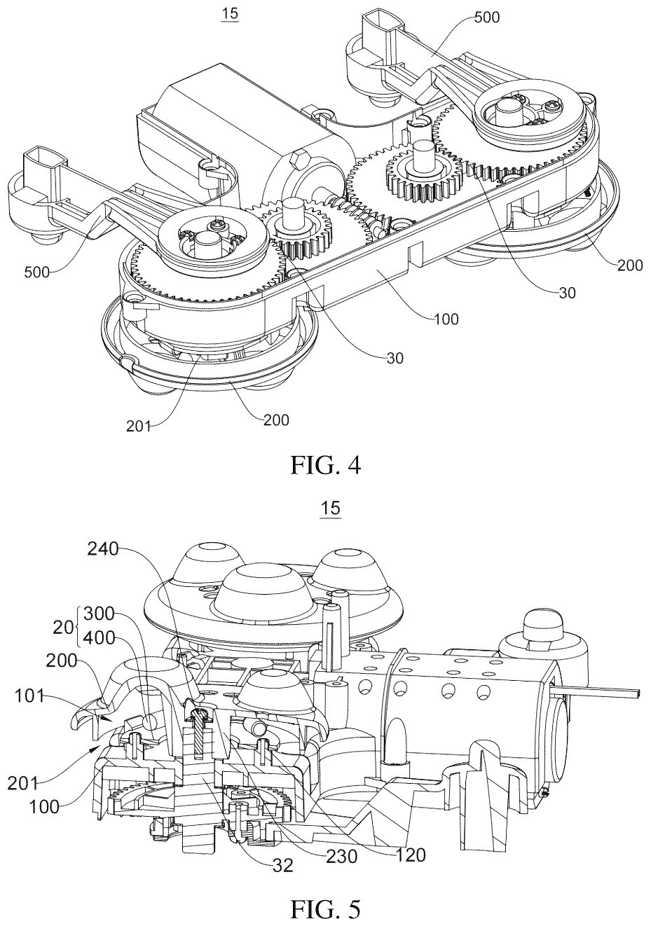

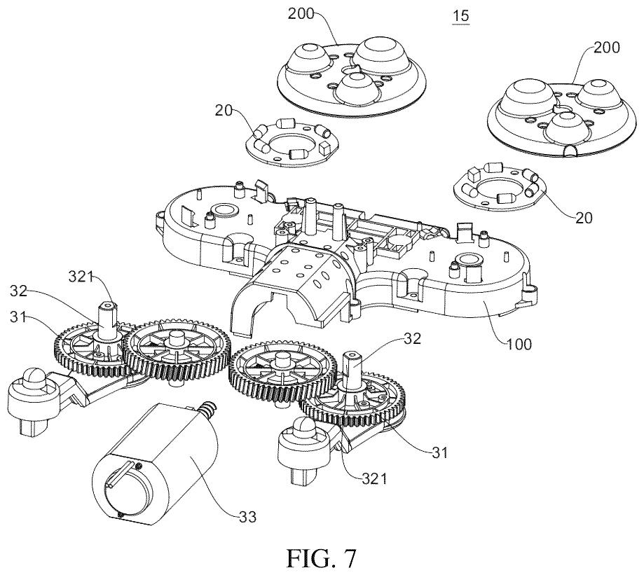

As shown in FIGS. 4 and 5, the foot massager 1 further includes a drive assembly 30. The drive assembly 30 is specifically mounted at a lower side of the mounting member 100. The drive assembly 30 is driveably connected to the massager head 200 and is configured to drive the massager head 200 to massage the foot. Specifically, as shown in FIGS. 7 and 10, the mounting member 100 defines a mounting hole 110, and the drive assembly 30 includes a drive motor 33, a gear set 31, and a rotation shaft 32. The drive motor 33 is connected to a power source via a power cord 16. The drive motor 33 drives the gear set 31. The rotation shaft 32 and the gear set 31 are driveably connected to each other. The rotation shaft 32 extends through the mounting hole 110. The massager head 200 is mounted on the rotation shaft 32, and the gear set 31 is configured to drive the rotation shaft 32 to rotate. The rotation shaft 32 passes through the mounting member 100 to be fixedly connected to the massager head 200 to enable the massager head 200 to rotate along with the rotation shaft 32.

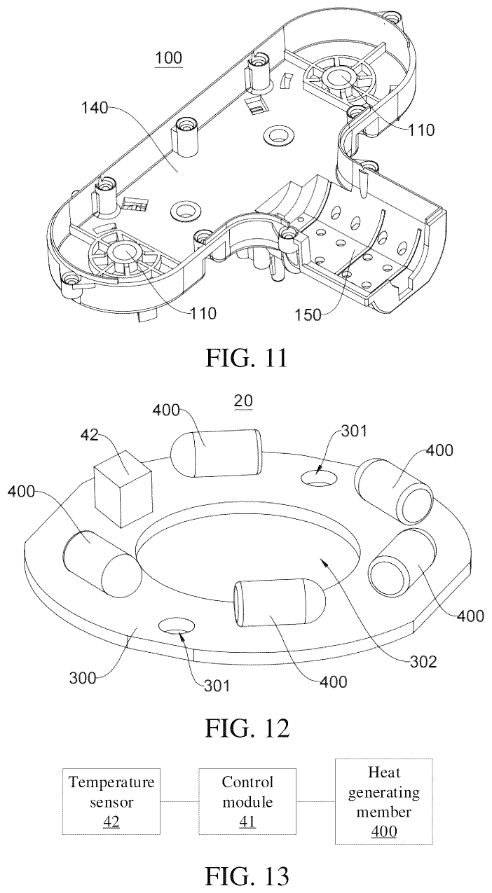

As shown in FIG. 2, FIG. 10, and FIG. 11, the mounting member 100 is disposed on the lower housing 13, the lower housing 13 is provided with an enclosing projection 132 corresponding to the mounting member 100. The mounting member 100 and the enclosing projection 132 cooperatively form a mounting space. The drive assembly 30 is received in the mounting space. The mounting space includes a gear receiving portion 140 and a motor receiving portion 150. The gear set 31 is received in the gear receiving portion 140, and the drive motor 33 is received in the motor receiving portion 150.

Further, as shown in FIG. 9, the massager head 200 is further provided with a connection sleeve 230. The connection sleeve 230 is sleeved onto the rotation shaft 32. The connection sleeve 230 defines a connection hole. A size and a configuration of the connection hole is the same as that of the rotation shaft 32. A portion of the rotation shaft 32 extending out from the mounting member 100 extends into the connection hole, such that the connection sleeve 230 is sleeved onto the rotation shaft 32. As shown in FIG. 9, a first limiting plane 232 is provided on an inner wall of the connection sleeve 230. As shown in FIG. 7, a second limiting plane 321 is provided on the rotation shaft 32. When the connection sleeve 230 is sleeved onto the rotation shaft 32, the first limiting plane 232 and the second limiting plane 321 abut against each other, preventing the rotation shaft 32 from rotating inside the connection sleeve 230 and enabling the rotation shaft 32 and the connection sleeve 230 to rotate synchronously. One or more first limiting plane 232 and one or more second limiting plane 321 may be arranged. In the present embodiment, the massager head 200 is fixed to the rotation shaft 32 by a fastener 240. The massager head 200 defines a fastening hole 213. The fastening hole 213 is defined in a center of the top wall 210 and is communicated to an interior of the connection sleeve 230. The fastener 240 may extend through the fastening hole. The fastener 240 may be a fastening screw. By arranging the fastener 240, connection stability between the massager head 200 and the rotation shaft 32 can be further improved. Further, a peripheral side of the connection sleeve 230 is arranged with a plurality of inclined reinforcement bars 231. By arranging the plurality of inclined reinforcement bars 231, strength of the connection sleeve 230 is improved, and the connection stability is further enhanced.

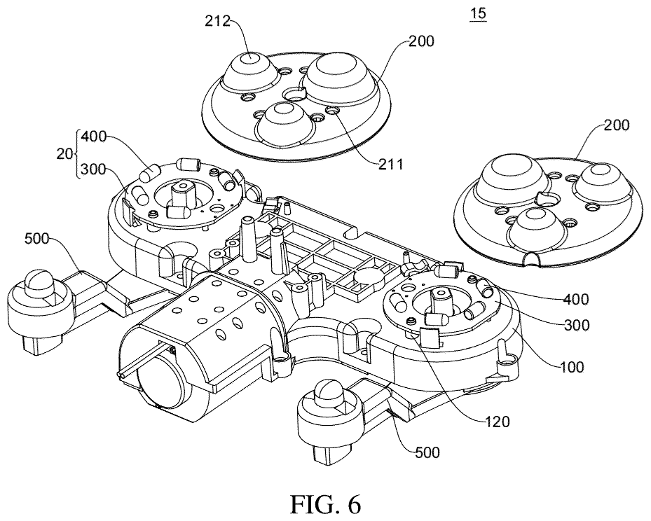

As shown in FIG. 6, in an embodiment, the heating assembly 20 is fixedly mounted on the mounting member 100. Further, the heating assembly 20 includes a fixing plate 300 and a heat generating member 400. The fixing plate 300 is configured to allow the heat generating member 400 to be mounted thereon. The heat generating member 400 is disposed on the fixing plate 300, and that is, the heat generating member 400 is disposed at an upper side of the fixing plate 300. The heat generating member 400 may be a heat generating bulb or an electric heating wire. Of course, the heat generating member 400 may be other heat generating members that can heat surrounding air.

As shown in FIGS. 10 and 12, the fixing plate 300 is fixedly mounted to the mounting member 100. Specifically, the fixing plate 300 defines a fixing hole 301, and the mounting member 100 is provided with a support connection post 120 corresponding to the fixing hole 301. The support connection post 120 is inserted into the fixing hole 301 to support and fix the fixing plate 300. The support connection post 120 is provided with a support portion 121 and a connection portion 122. A diameter of the support portion 121 is greater than a diameter of the connection portion 122. The diameter of the connection portion 122 is the same as a diameter of the fixing hole 301. The connection portion 122 may extend through the fixing hole 301 to be securely connected to the fixing plate 300, however, the support portion 121 is unable to extend through the fixing hole 301 and is thereby abutted against a bottom surface of the fixing plate 300. By arranging the support connection post 120, the fixing plate 300 can be suspended and mounted on the mounting member 100, a spacing is formed between the fixing plate 300 and the mounting member 100. In this way, contact between the mounting member 100 and the heating assembly 20 for heat conduction can be avoided. Of course, the fixing plate 300 may be fixed to the mounting member 100 by screws, rivets, or the like, for maintaining a relative positional relationship between the fixing plate 300 and the mounting member 100. In the present embodiment, two or more support connection posts 120 may be provided, and the two or more support connection posts 120 are spaced apart from each other and are evenly distributed on the mounting member 100 to enhance stability of supporting and fixing.

As shown in FIGS. 6 and 10, the mounting member 100 is further arranged with an upwardly protruding snap hook 130. The snap hook 130 is hooked to an edge of the fixing plate 300. By secured the edge of the fixing plate 300 with the snap hook 130, the fixing plate 300 can be positioned and fixed based on the snap hook 130 and the support connection post 120 cooperatively, even without being fastened to the mounting member 100 by screws or rivets. In this way, the fixing plate 300 is prevented from moving upwardly to be detached from the mounting member 100, further improving the connection stability of the fixing plate 300. In the present embodiment, two or more snap hooks 130 are provided, and the two or more snap hooks 130 are spaced apart from each other, surrounding the edge of the fixing plate 300, and are evenly distributed on the mounting member 100, so as to balance a force applied to the fixing plate 300.

Further, the fixing plate 300 is an annular structure, such that a center of the fixing plate 300 defines a through hole 302. The rotation shaft 32 extends through the through hole 302 to be fixedly connected to the massager head 200. A diameter of the through hole 302 is greater than the diameter of the rotation shaft 32, such that the rotation shaft 32 can pass through the through hole 302, and the rotation shaft 32 does not contact the fixing plate 300. In this way, unnecessary friction is reduced, and a service life of the components is increased.

As shown in FIGS. 12 and 13, the foot massager 1 further includes a control module 41 and a temperature sensor 42. The control module 41 is disposed on the massager body 10 and is more specifically disposed on the upper housing 12. The temperature sensor 42 is disposed on the fixing plate 300 and is disposed near the heat generating member 400. The temperature sensor 42 and the heat generating member 400 are electrically connected to the control module 41. The control module 41 may be a Field Programmable Gate Array (FPGA), a Microcontroller Unit (MCU), and so on. The temperature sensor 42 is configured to detect a temperature of the heating space 101 and feed back the temperature to the control module 41. The control module 41 controls an operating state of the heat generating member 400 according to information fed back from the temperature sensor 42. In this way, the temperature of the heating space 101 is controlled and is prevented from being excessively low or excessively high, improving the user experience.

In an embodiment, the control module 41 stores a preset maximum temperature value. The temperature sensor 42 is configured to detect the temperature of the heating space 101 and send the temperature to the control module 41. The control module 41 is configured to control the heat generating member 400 to stop heating when the temperature of the heating space 101 exceeds the preset maximum temperature value. In this way, the user is prevented from being scalded when the temperature of the heating space 101 is excessively high, improving safety of using the massager.

In another embodiment, a plurality of heat generating members 400 are provided. The control module 41 is configured to control the number of operating heat generating members 400 to control the temperature of the heating space 101. In an example, the control module 41 may control the number of the operating heat generating members according to a temperature demand, such that the temperature of the heating space 101 may reach a preset temperature. For example, a maximum temperature that can be achieved may be t1 when the control module 41 controls two heat generating members 400 to operate, and a maximum temperature that can be achieved may be t2 when the control module 41 controls four heat generating members 400 to operate, and a maximum temperature that can be achieved may be t3 when the control module 41 controls six heat generating members 400 to operate.

In another embodiment, during a first predetermined time duration, the control module 41 is configured to control the heat generating member 400 to generate heat for a second predetermined time duration to control the temperature of the heating space 101. The first predetermined time duration is an operation cycle of the generating member 400. The second predetermined time duration is a time duration in which the heat generating member 400 generates heat. A plurality of first predetermined time durations and a plurality of second predetermined time durations may be set. Different predetermined time durations represent different controlled temperature levels. By controlling an operating time duration of the heat generating member 400 (i.e., the heat generating member 400 operates or stops operating alternately), the temperature of the heating space 101 is controlled. In an embodiment, three first predetermined time durations are set, and each of the three first predetermined time durations is half an hour; and three second predetermined time durations are set, and the three first predetermined time durations are 10 minutes, 20 minutes, and 30 minutes, respectively. For example, within half an hour, the heat generating member 400 is controlled to operate for 10 minutes, and an average temperature is t4; within half an hour, the heat generating member 400 is controlled to operate for 20 minutes, and an average temperature is t5; within half an hour, the heat generating member 400 is controlled to operate for 30 minutes, and an average temperature is t6. In this way, three temperature levels are formed. The user may perform adjustment to reach any temperature level according to the user's own feelings, and the control module 41 adjusts the temperature in the heating space 101 to reach a target temperature according to the temperature level, further enhancing the user experience.

In addition, it is understood that each of the above embodiments is only an exemplary illustration of the present disclosure, and technical solutions of each embodiment may be used in any combination or collocation as long as there is no conflict in the technical features, no contradiction in the structure, and no departing from the inventive concept of the present disclosure.

Finally, it should be noted that the above embodiments are only used to illustrate the technical solutions of the present disclosure but not to limit the present disclosure. Although the application has been described in detail with reference to the embodiments, any ordinary skilled person in the art shall understand that the technical solutions recorded in the above embodiments may be modified, or some of the technical features therein may be replaced with equivalent ones. These modifications or replacements do not make the corresponding technical solution deviate from the essence of the technical solutions of the present disclosure.

What is claimed is:

1. A foot massager, comprising:
a massager body, defining a foot receiving cavity;
a mounting member, mounted on the massager body;
a massager head, configured to massage a foot of a user, wherein a heating space is formed between the massager head and the mounting member, at least one heat-transmitting hole is defined in the massager head, and the at least one heat-transmitting hole provides communication between the heating space and the foot receiving cavity; and
a heating assembly, received in the heating space, wherein the heating assembly is configured to heat the heating space and the massager head.

2. The foot massager according to claim 1, wherein at least one of the at least one heat-transmitting hole is located directly facing towards the heating assembly.

3. The foot massager according to claim 1, wherein the massager head comprises a top wall and at least one massaging protrusion, the at least one massaging protrusion is disposed on the top wall, and the at least one heat-transmitting hole is defined in the top wall and is located near the at least one massaging protrusion.

4. The foot massager according to claim 3, wherein the massager head further comprises a side wall surrounding the top wall; the top wall, the side wall and the mounting member cooperatively define the heating space.

5. The foot massager according to claim 4, wherein the side wall and the mounting member are spaced apart from each other, and an air intake gap is formed between the side wall and the mounting member.

6. The foot massager according to claim 3, wherein the number of the at least one massaging protrusion is at least two, and at least one of the at least one heat-transmitting hole is defined between at least one pair of adjacent ones of the at least two massaging protrusions.

7. The foot massager according to claim 6, wherein the number of the at least one massaging protrusion is three, and the number of the at least one heat-transmitting hole is six; two of the six heat-transmitting holes are located between every two adjacent ones of the three massaging protrusions, and two of the six heat-transmitting holes are located on a side of each of the three massaging protrusions.

8. The foot massager according to claim 1, wherein the foot massager further comprises a drive assembly, the drive assembly is mounted on the mounting member, and the drive assembly is driveably connected to the massager head.

9. The foot massager according to claim 8, wherein the mounting member defines a mounting hole, the drive assembly comprises a gear set and a rotation shaft driveably connected to the gear set, the rotation shaft extends through the mounting hole, and the massager head is mounted on the rotation shaft.

10. The foot massager according to claim 9, wherein the massager head is further provided with a connection sleeve, the connection sleeve is provided with a first limiting plane therein, a second limiting plane is provided on the rotation shaft; the connection sleeve is sleeved onto the rotation shaft, and the first limiting plane and the second limiting plane abut against each other.

11. The foot massager according to claim 10, wherein a plurality of reinforcing ribs are arranged at a peripheral side of the connection sleeve.

12. The foot massager according to claim 1, wherein the heating assembly is fixedly mounted on the mounting member.

13. The foot massager according to claim 12, wherein the heating assembly comprises a fixing plate and a heat generating member mounted on the fixing plate; the fixing plate is fixedly mounted on the mounting member.

14. The foot massager according to claim 13, wherein the fixing plate defines a fixing hole, the mounting member is provided with a support connection post, and the support connection post is provided with a support portion and a connection portion; a diameter of the support portion is greater than a diameter of the connection portion; the connection portion extends through the fixing hole, and the support portion abuts against a bottom of the fixing plate to support and fix the fixing plate.

15. The foot massager according to claim 13, wherein the mounting member is provided with an upwardly protruding snap hook, the snap hook is hooked to an edge of the fixing plate to fix the fixing plate to the mounting member.

16. The foot massager according to claim 13, wherein the fixing plate is ring-shaped, and a through hole is defined in a center of the fixing plate; the foot massager further comprises a drive assembly, the drive assembly is mounted on the mounting member, the drive assembly comprises a gear set mounted on the mounting member and a rotation shaft driveably connected with the gear set, the mounting member defines a mounting hole, and the rotation shaft extends through the mounting hole and the through hole and is then fixedly connected with the massager head.

17. The foot massager according to claim 13, wherein the heat generating member is a heat generating bulb or an electric heating wire.

18. The foot massager according to claim 13, wherein the foot massager further comprises a control module and a temperature sensor; the temperature sensor is mounted on the fixing plate and is disposed near the heat generating member, and the temperature sensor and the heat generating member are electrically connected to the control module.

19. The foot massager according to claim 18, wherein the temperature sensor is configured to detect a temperature of the heating space and send the temperature to the control module, and the control module is configured to control the heat generating member to stop heating when the temperature of the heating space exceeds a preset maximum temperature value.

20. The foot massager according to claim 18, wherein a plurality of heat generating members are provided;
wherein, the control module is configured to control the number of operating heat generating members of the plurality of heat generating members to further control the temperature of the heating space;
or
the control module is configured to control, within a first predetermined time duration, the plurality of heat generating members to generate heat for a second predetermined time duration to further control the temperature of the heating space, wherein the first predetermined time duration is an operating cycle of the plurality of heat generating members, and the second predetermined time duration is a time duration in which the plurality of heat generating members generate heat.
